(19) United States
(12) Patent Application Publication
(10) Pub. No.: US 2009/0138112 A1
(43) Pub. Date: May 28, 2009

(54) Designing An Apparatus To Substantially Minimize Exergy Destruction

(76) Inventors: Amip Shah, Santa Clara, CA (US); Chandrakant Patel, Fremont, CA (US); Ratnesh Sharma, Fremont, CA (US); Cullen Bash, Los Gatos, CA (US); Abdlmonem Beitelmal, Los Altos, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 12/254,571

(22) Filed: Oct. 20, 2008

Related U.S. Application Data
(60) Provisional application No. 60/990,438, filed on Nov. 27, 2007.

(51) Int. Cl. G06F 19/00

(52) U.S. Cl. 700/97

(57) ABSTRACT

In a method of designing an apparatus formed of at least one component to substantially minimize exergy destruction, at least one of one or more candidate materials and one or more candidate processes are identified. The one or more candidate materials are capable of being used in forming the at least one component and the one or more candidate processes are associated with either or both of the one or more candidate materials and the at least one component. Exergy destruction values of at least one of the one or more candidate materials and the one or more candidate processes are determined. In addition, at least one of the one or more candidate materials and the one or more candidate processes having the substantially lowest exergy destruction values are selected for the apparatus design.

### CROSS-REFERENCE TO RELATED APPLICATION:

The present application claims priority from the provisional application Ser. No. 60/990,438, filed Nov. 27, 2007, the contents of which are incorporated herein by reference in their entirety.

### BACKGROUND

There has been a substantial increase in the number of data centers, which may be defined as locations, for instance, rooms that house computer systems arranged in a number of racks. The computer systems are typically designed to perform jobs such as, providing Internet services or performing various calculations. In addition, data centers typically include cooling systems to substantially maintain the computer systems within desired thermodynamic conditions.

The computer systems housed in data centers are often designed and implemented with a focus on minimizing the temperature generated by the computer systems to thereby minimize the energy consumed by the cooling systems in dissipating the generated heat. In addition, the cooling systems are often designed and implemented in various manners to substantially maximize efficiency in the delivery of cooling airflow to the computer systems.

Although current methods and systems for substantially minimizing energy consumption in data centers are relatively effective, there remains room for improvement.

### BRIEF DESCRIPTION OF THE DRAWINGS

Features of the present invention will become apparent to those skilled in the art from the following description with reference to the figures, in which:

FIG. 1 shows a simplified block diagram of a system for designing an apparatus formed of components to substantially minimize exergy destruction, according to an embodiment of the invention;

FIG. 2 illustrates a flow diagram of a method of designing an apparatus formed of at least one component that substantially minimizes exergy destruction, according to an embodiment of the invention;

FIG. 3 illustrates a flow diagram of a method of determining the exergy destruction values of the one or more candidate materials used in designing the apparatus of FIG. 2, according to an embodiment of the invention;

FIG. 4 illustrates a flow diagram of a method of determining the exergy destruction values of the components fabricated from the one or more candidate materials used in designing the apparatus of FIG. 2, according to an embodiment of the invention;

FIG. 5 illustrates a flow diagram of a method of determining the exergy destruction values of one or more candidate materials and one or more candidate processes used in designing the apparatus of FIG. 2, according to another embodiment of the invention;

FIG. 6 illustrates a flow diagram of a method of determining the exergy destruction values of the one or more candidate materials used in designing the apparatus of FIG. 2, according to a further embodiment of the invention;

FIG. 7 illustrates a flow diagram of a method of reducing the exergy destruction values of one or more components used in designing the apparatus of FIG. 2, according to an embodiment of the invention; and

FIG. 8 shows a block diagram of a computing apparatus configured to implement or execute the design tool depicted in FIG. 1, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Disclosed herein are systems and methods of designing an apparatus formed of a plurality of components, where the apparatus is designed to substantially minimize exergy destruction or, synonymously, to substantially maximize environmental sustainability. In one example, the exergy destroyed by the designed apparatus is substantially minimized through selection of either or both of materials and processes used to fabricate the components having the substantially lowest exergy destruction values during at least one of extraction and fabrication of the materials. In another example, the exergy destruction is substantially minimized through selection of either or both of materials and processes having the substantially lowest exergy destruction values during at least one of fabrication, use, disposal of, and re-use of the components.

The exergy destroyed may further be substantially minimized through additional considerations with respect to either or both of the materials and the processes used in the design of the apparatus. For instance, the supply chains associated with either or both of the materials and the processes having the substantially lowest exergy destruction values may be selected. Additional examples of manners in which the exergy destroyed in the fabrication of an apparatus may be substantially minimized are discussed herein below.

Generally speaking, “exergy” is synonymous with “available energy” and may be defined as a measure of the amount of work a system has the ability of performing. In comparison with energy, which cannot be destroyed because it merely goes from one state to another, exergy, or available energy, is typically destroyed as the system performs work, or consumes available resources. In this sense, the measure of exergy destroyed thus addresses both energy and material consumption. More particularly, the second law of thermodynamics necessitates the presence of irreversibilities (or entropy generation) in any real, physical system. These irreversibilities essentially reduce the amount of work that may be available for utilization by the system. These irreversibilities lead to destruction of available energy or resources (that is, exergy). For example, the process of converting coal into electricity is an irreversible process and the conversion, therefore, corresponds to a destruction of exergy.

Through implementation of the methods and systems disclosed herein, the design of apparatuses may be performed to substantially minimize destruction of available resources. As such, the apparatuses may be designed to improve the environmental sustainabilities associated with the designed apparatuses as compared with conventionally designed apparatuses.

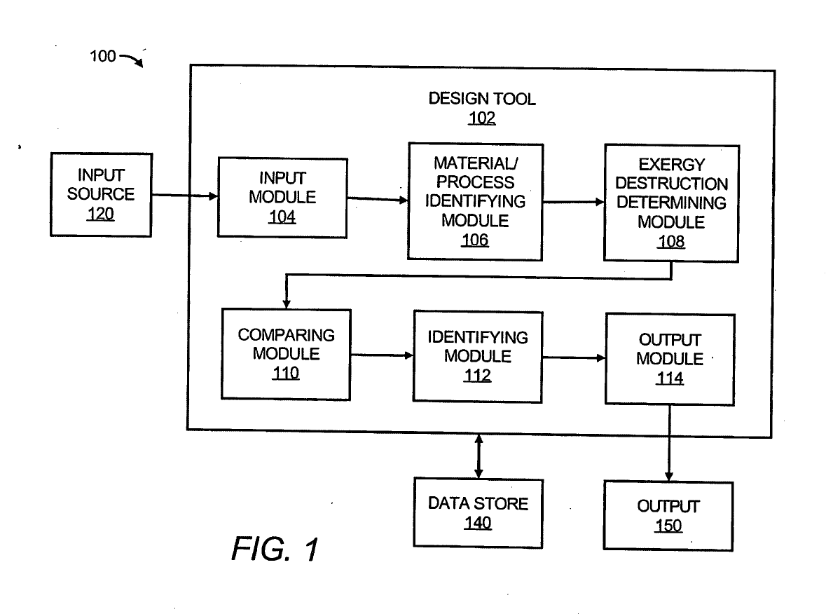

With reference first to FIG. 1, there is shown a simplified block diagram of a system 100 for designing an apparatus formed of components to substantially minimize exergy destruction, according to an example. It should be understood that the system 100 may include additional elements and that some of the elements described herein may be removed and/or modified without departing from the scope of the system 100.

As shown, the system 100 includes a design tool 102, which may comprise software, firmware, or hardware and is configured to design an apparatus formed of at least one component to substantially minimize exergy destruction, and therefore a substantially maximized environmental sustainability. According to an example, the design tool 102 comprises a plug-in module for use with another software tool, such as, MCAD, CFD, FEM, etc. In any regard, the design tool 102 is depicted as including an input module 104, a material/process identifying module 106, an exergy destruction determining module 108, a comparing module 110, an identifying module 112, and an output module 114.

In instances where the design tool 102 comprises software, the design tool 102 may be stored on a computer readable storage medium and may be executed by the processor of a computing device (not shown). In these instances, the modules 104-114 may comprise software modules or other programs or algorithms configured to perform the functions described herein below. In instances where the design tool 102 comprises firmware or hardware, the design tool 102 may comprise a circuit or other apparatus configured to perform the functions described herein. In these instances, the modules 104-114 may comprise one or more of software modules and hardware modules.

In any regard, the design tool 102 may be executed or implemented to design an apparatus, such as, an electronic apparatus including a desk top computer, a laptop computer, a server, a personal digital assistant, a printer, air conditioning unit components, etc., or a combination of multiple systems, such as, servers on an electronics cabinet, an IT data center, a print factory, an air conditioning system, etc. Other types of apparatus include, for instance, engines, compressors, etc. The apparatus may further be designed as part of combinations of multiple systems, such as, automobiles, aircrafts, ships, etc. Various examples of manners in which the design tool 102 may design individual and multiple systems such that the apparatus substantially minimizes exergy destruction in its fabrication, implementation, and/or disposal are described herein below.

As shown in FIG. 1, the input module 104 is configured to receive input from an input source 120. The input source 120 may comprise a computing device, through which data may be inputted into the design tool 102. The design tool 102 and the input source 120 may form part of the same computing device or different computing devices. The inputted data may include, for instance, a pool of candidate materials that may be used to fabricate components of the apparatus. By way of example, the components may include, for instance, chassis, processors, power supplies, memories, hard disk drives, printer components, cooling system components, UPS's, batteries, cables, seats, wheels, lighting, etc. In addition, the candidate materials may include, for instance, plastics, silicon, metals, polymers, liquids, gases, etc., which form the components.

The inputted data may also include exergy destruction values associated with each of the candidate materials. The exergy destruction values may be based upon the amount of exergy destroyed during respective extraction and/or fabrication processes of the candidate materials. In addition, or alternatively, the exergy destruction values may be based upon the amount of exergy destroyed during respective disposal processes of the candidate materials. In addition, the exergy destruction values may also be based upon the ability to re-use or reclaim the exergy destroyed during implementation and/or disposal of the candidate materials. The exergy destruction values may further be based upon the amount of exergy destroyed in the respective supply chains associated with the candidate materials. In one regard, therefore, the exergy destruction values may be based upon one or more stages in the respective life cycles of the candidate materials. The respective life cycles may include extraction, fabrication, use, disposal, and re-use of the candidate materials.

The inputted data may further include exergy destruction values associated with each of the components. Similar to the candidate materials, the respective exergy destruction values for the components may be based upon the amount of exergy destroyed during one or more of the fabrication, transportation, use, disposal, and re-use processes of the components. As such, the exergy destruction values of the components may be based upon one or more stages in the respective life cycles of the components.

Additional factors that may be considered in determining the exergy destruction values of the respective candidate materials/processes used in creating the components are presented herein below.

The exergy destruction values associated with the materials, processes, and/or the components may be determined through application of thermodynamic models designed to calculate the overall environmental impact of the materials, processes, and/or components. More particularly, for instance, all of the energy and material flows entering into and outputed from a particular stage in a life cycle of a material may be evaluated in calculating the exergy destruction values for the particular life stages. In addition, the exergy destruction values for each of the life cycle stages may be summed to calculate the total exergy destruction value for the entire life cycle of a particular material, process, and/or component. Furthermore, the exergy destruction values may be calculated from exergy flows associated with the energy used as well as exergy flows associated with the materials consumed in the processes performed during one or more stages in the life cycles of the particular material, process, and/or component.

By way of example with respect to the thermodynamic models, the exergy loss values (ψ) may be calculated through implementation of the following equation:

ψ=(h−h₀)−T₀(s−s₀). Equation (1)

In Equation (1), h is the enthalpy of the candidate material/process, T is the temperature, s is the entropy, and the subscript ‘0’ corresponds to a reference or ambient state against which the candidate material/process is evaluated. In addition, the exergy (ψ) is per unit mass of the candidate material/process at steady state with negligible kinetic and potential energy. If the total exergy of the system is to be calculated, then Equation (1) may be multiplied by the mass (or equivalently, the density and volume) of the candidate material/process.

Equation (1) may approximately be reduced in terms of temperature and specific heat Cₚ as follows:

ψ=Cₚ(T−T₀)−T₀Cₚ ln(T/T₀). Equation (2)

Equation (1) or Equation (2) may be used with traditional thermodynamic methods to determine the exergy loss of the system. One example of a thermodynamic formulation is as follows:

ψ_{d}=Σψᵢₙ−Σψₒᵤₜ−Δψ. Equation (3)

In Equation (3), the subscript d indicates the amount of exergy destroyed, the subscript ‘in’ indicates the amount of exergy supplied into the system, the subscript ‘out’ indicates the amount of exergy leaving the system, and Δψ indicates the change of exergy within the system, as measured by either of Equation (1) or Equation (2), for example. Equation (3) may also be written per unit time, in which case, each of the exergy terms ψ would represent rate of exergy change rather than just the exergy.

In one example, the design tool 102 may be programmed to perform the environmental impact calculations. In another example, the environmental impact calculations of the materials and/or components may be performed through implementation of an environmental impact determination model by an external computing apparatus.

The input module 104 may provide a graphical user interface through which a user may provide instructions or input information into the design tool 102. The design tool 102 may store the data received from the input source 120 and the user in a data store 140, which may comprise volatile and/or non-volatile memory, such as DRAM, EEPROM, MRAM, flash memory, and the like. In addition, or alternatively, the data store 140 may comprise a device configured to read from and write to a removable media, such as, a floppy disk, a CD-ROM, a DVD-ROM, or other optical or magnetic media.

According to an example, the material/process identifying module 106 is configured to identify one or more candidate materials/processes capable of being used in fabricating the components of an apparatus. The material/process identifying module 106 may also identify candidate processes capable of being used in either or both of extracting and fabricating the candidate materials. By way of example, the material identifying module 106 may identify which materials and/or processes are suitable for use in forming the components and whether the materials are replaceable with other suitable materials. For instance, if the apparatus comprises a computing device, the material/process identifying module 106 may identify different grades of plastic or other materials, such as, aluminum, that may be suitable for use in forming a casing of the computing device.

The exergy destruction determining module 108 is configured to determine the exergy destruction values associated with each of the materials and/or processes identified by the material/process identifying module 106. The exergy destruction determining module 108 may also determine the exergy destruction values associated with the components formed by the materials, as well as, the exergy destruction values associated with the processes used throughout the life-cycles of the materials. As discussed above, the exergy destruction values may be determined through implementation of an environmental impact model.

The comparing module 110 is configured to compare the exergy destruction values of the candidate materials and/or candidate processes suitable for use in forming the components. The comparing module 110 may also compare the exergy destruction values of the components formed from the candidate materials. The comparing module 110 is configured to compare the respective exergy loss values of the candidate materials/candidate processes and their resulting components with other candidate materials/candidate processes and their resulting components to identify which of the candidate materials/candidate processes and their resulting components have the substantially lowest exergy destruction values.

The identifying module 112 is configured to identify the candidate materials, candidate processes, and/or the components resulting from the candidate materials/candidate processes that have the substantially lowest exergy destruction values. In addition, the output module 114 is configured to output the identified candidate materials, candidate processes, and/or the components to an output 150. The output 150 may comprise, for instance, a display configured to display the identified set of components. In addition, or alternatively, the output 150 may comprise a fixed or removable storage device on which the identified set of components is stored. As a further alternative, the output 150 may comprise a connection to a network over which the identified set of components may be communicated.

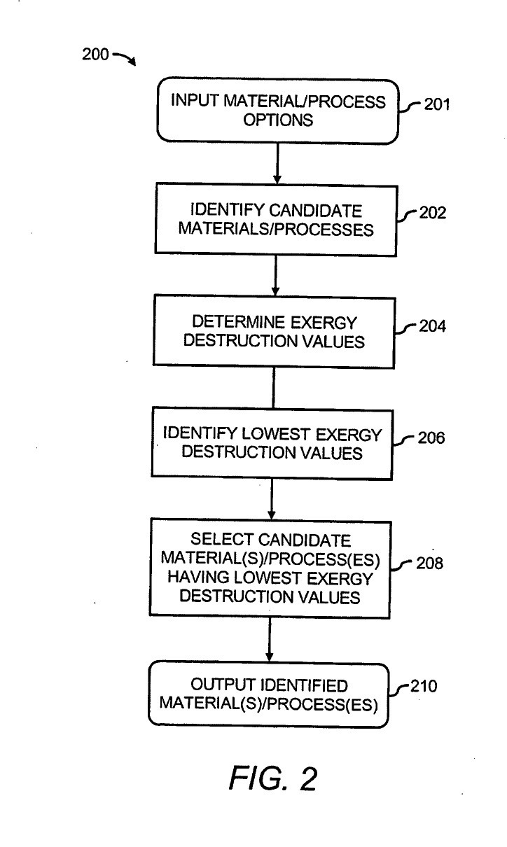

Examples of methods in which the system 100 may be employed to design an apparatus that substantially minimizes exergy destruction, and therefore, substantially maximizes environmental sustainability, will now be described with respect to the following flow diagrams of the methods 200-700 respectively depicted in FIGS. 2-7. It should be apparent to those of ordinary skill in the art that the methods 200-700 represent generalized illustrations and that other steps may be added or existing steps may be removed, modified or rearranged without departing from the scopes of the methods 200-700.

The descriptions of the methods 200-700 are made with reference to the system 100 illustrated in FIG. 1, and thus makes reference to the elements cited therein. It should, however, be understood that the methods 200-700 are not limited to the elements set forth in the system 100 Instead, it should be understood that the methods 200-700 may be practiced by a system having a different configuration than that set forth in the system 100.

A controller, such as a processor (not shown), may implement or execute the design tool 102 to perform one or more of the methods 200-700 in designing an apparatus that substantially minimizes exergy destruction throughout a portion or the entire life cycle of the apparatus or the components forming the apparatus.

With reference first to FIG. 2, there is shown a flow diagram of a method 200 of designing an apparatus formed of at least one component that substantially minimizes exergy destruction, according to an example. As shown in FIG. 2, material/process options for the apparatus are inputted into the input module 104 at step 201. The material options generally comprise different candidate materials that are suitable for use in forming one or more of the components forming the apparatus. The candidate materials may include, for instance, plastics, silicon, metals, polymers, liquids, gases, etc., used to form parts of the components. The process options may include different candidate processes that are suitable for at least one of extracting and fabricating the candidate materials. The process options may also include different candidate processes that are suitable for at least one of fabricating, using, disposing, and re-using of the components.

As discussed above, the components may include, for instance, chassis, processors, packages, memories, hard disk drives, printer components, optical scanning equipment components, cooling system components, UPS components, batteries, cables, etc.

At step 202, candidate materials/candidate processes suitable for use in forming the components of the apparatus are identified from the material/processes options inputted at step 201. For example, the material/process identifying module 106 may identify materials that may be replaceable with respect to each other and are therefore able to perform one or more of the same functions. By way of particular example, the material/process identifying module 106 may identify a particular plastic material for use in forming the casing of a computing device and a compatible plastic or metal material, which may replace the particular plastic material in forming the computing device casing. As another example, the material/process identifying module 106 may identify a particular process of molding a material to form the casing and a compatible process of bending a material to form the casing.

At step 204, the exergy destruction values associated with each of the identified candidate materials/candidate processes are determined. According to a first example, the exergy destruction values may have been inputted from the input source 120 and stored in the data store 140. In this example, the exergy destruction determining module 108 may determine the exergy destruction values by accessing the data store 140 and retrieving the exergy destruction values. According to a second example, the exergy destruction determining module 108 may determine the exergy destruction values through implementation of an environmental impact model. In this example, the exergy destruction determining module 108 may translate the environmental impact model into exergy destruction values. In either example, the exergy destruction values may be determined for one or more stages in the life cycles of the candidate materials and/or for one or more candidate processes employed during one or more stages in the life cycles of the candidate materials.

At step 206, the exergy destruction values of the candidate materials and/or candidate processes are compared to identify one or more of the candidate materials and/or candidate processes having the substantially lowest exergy destruction values. In addition, the one or more candidate materials that require the least amount of resources among the candidate materials are selected, as indicated at step 208. In addition or alternatively, at step 208, the one or more candidate processes that result in the lowest exergy destruction losses are selected.

At step 210, either or both of the candidate materials and the candidate processes identified as having the substantially lowest exergy destruction values are outputted to the output 150, which may comprise at least one of a display, a storage device, a printing device, and a network connection.

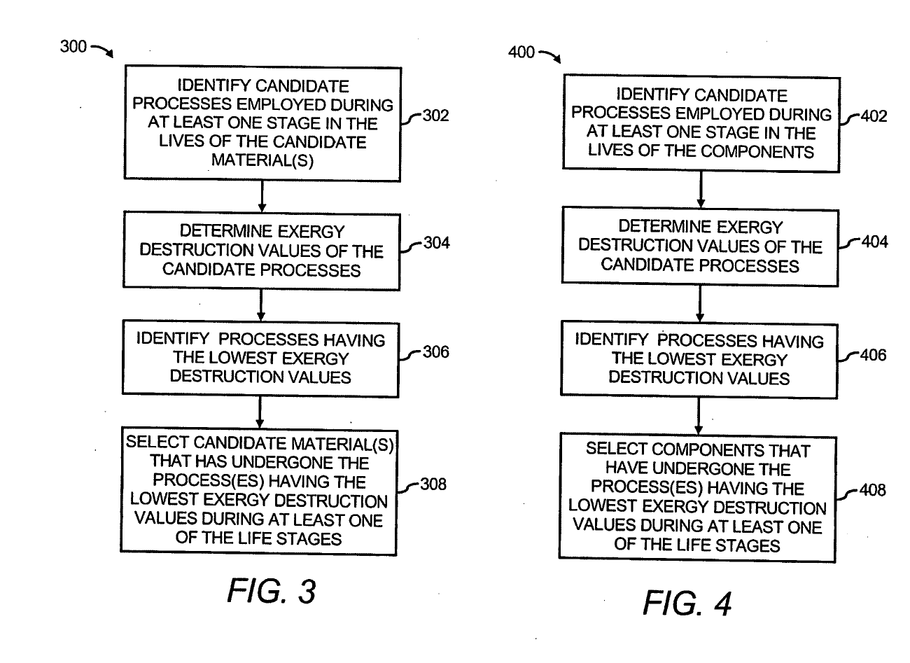

With reference now to FIG. 3, there is shown a flow diagram of a method 300 of determining the exergy destruction values of the one or more candidate materials, according to an example. Thus, for instance, the steps 304-308 in the method 300 comprise more detailed descriptions of an example of steps 204-208, respectively, in FIG. 2. In addition, or alternatively, the steps contained 302-308 in the method 300 may be performed in place of steps 204-208 in the method 200.

In any regard, at step 302, candidate processes employed during at least one stage in the lives of the candidate materials are identified. More particularly, for instance, the material/process identifying module 106 may identify which candidate processes are capable of being performed in at least one of extracting, fabricating, using, disposing, and re-using the candidate materials.

At step 304, the exergy destruction values of the candidate processes employed during at least one stage in the lives of the candidate materials are determined. More particularly, for instance, the exergy destruction determining module 108 may determine the exergy destruction values of a first process employed to extract, fabricate, use, dispose of, and/or re-use a first material and a second process employed to extract, fabricate, use, dispose of, and/or re-use a second material, where the first material and the second material comprise compatible replacement materials for each other. By way of example, the exergy destroyed for the first process may comprise the amount of energy and material used in extracting the first material. As another example, the exergy destroyed for the first process may comprise the amount of energy used and material consumed in disposing of the first material.

The exergy destruction determinations may also be made based upon secondary or tertiary considerations, such as, the exergy destruction levels of the energy used to power the candidate processes. By way of example, different types of power transmission infrastructures, such as, through use of renewable energy sources (photovoltaics, fuel cells, solar, etc.), through use of various power generation and transmissions (AC vs. DC voltage), through use of high efficiency turbines with a power generation cycle, etc., may be used to power the candidate processes. As another example, some or all of the candidate materials may be processed through use of different manufacturing processes, such as, various chemical operations employed to fabricate a plastic material, various drilling and excavation operations to extract a particular mineral, etc. The different processes may each require different amounts of energy or materials and may thus have different exergy destruction levels.

The exergy destruction values may be determined while considering various other factors with regard to the energy used for processes employed during at least one of the life stages of the candidate materials. These other factors may include, for instance, the amount of raw fuel utilized to produce the energy used in extracting and/or fabricating the one or more materials, the amount of energy used to extract the raw fuel used to generate the electricity in fabricating the one or more materials, etc. Other factors may include, for instance, the power delivery process, the recycling/disposal costs of the one or more materials, transportation costs, etc.

At step 306, the processes having the substantially lowest exergy destruction values are identified. According to an example, the exergy destruction values resulting from processes associated with an entire life cycle of each candidate material may be compared with each other. In this example, the exergy destruction values for the processes may be summed for each of the candidate materials. According to another example, the exergy destruction values resulting from processes associated with one or more stages in the lives of the candidate materials may be compared with each other to identify the processes having the substantially lowest exergy destruction values.

In any regard, the identifying module 112 may select the one or more candidate materials that have undergone the process(es) having the lowest exergy destruction values during at least one of the life stages identified at step 306 for use in the design of one or more components of the apparatus, as indicated at step 308. In addition, the one or more candidate materials selected at step 308 may be outputted as discussed above with respect to step 210 in FIG. 2.

With reference now to FIG. 4, there is shown a flow diagram of a method 400 of determining the exergy destruction values of the components fabricated from the one or more candidate materials, according to another example. Thus, for instance, the steps 404-408 in the method 400 comprise more detailed descriptions of an example of steps 204-208, respectively, in FIG. 2. In addition, or alternatively, the steps contained 402-408 in the method 400 may be performed in place of steps 204-208 in the method 200. Furthermore, the method 400 may be performed in place of or in conjunction with the method 300.

At step 402, candidate processes employed during at least one stage in the lives of the components of the apparatus are identified. The candidate processes may include, for instance, various fabrication, use, disposal, re-use processes employed during one or more of the fabrication, use, and disposal stages of the lives of the components. By way of a particular example in which the apparatus comprises a personal computer, the components comprise a processor, a casing, etc. The fabrication processes for the casing, for example, may include an injection molding process, a bending/cutting process, etc. As another example, the disposal stage may include a recycling process, a destruction process, etc.

At step 404, the exergy destruction values associated with each of the processes employed during at least one stage in the lives of the components are determined. More particularly, for instance, the exergy destruction determining module 108 may determine the exergy destruction values of a first process employed to fabricate, use, dispose of, and/or re-use a first component and a second process employed to fabricate, use, dispose of, and/or re-use a second component, where the first component and the second component comprise compatible replacement components for each other. By way of a particular example, the exergy destroyed for the first process may comprise the amount of energy and material consumed in fabricating the first component. As another example, the exergy destroyed for the first process may comprise the amount of energy used and material consumed in using the first component.

Similarly to the materials used to fabricate the components, the exergy destruction determinations may also be made based upon secondary or tertiary considerations, such as, the exergy destruction levels of the energy used to power the candidate processes. By way of example, different types of power transmission infrastructures, such as, through use of renewable energy sources (photovoltaics, fuel cells, solar, etc.), through use of various power generation and transmissions (AC vs. DC voltage), through use of high efficiency turbines with a power generation cycle, etc., may be used to power the candidate processes. As another example, some or all of the components may be processed through use of different manufacturing processes, such as, various molding operations employed to fabricate a chassis, various bending and cutting operations, etc. The different manufacturing processes may each require different amounts of energy or materials and may thus have different exergy destruction levels.

The exergy destruction values may be determined while considering various other factors with regard to the energy used for processes employed during at least one of the life stages of the components. These other factors may include, for instance, the amount of raw fuel utilized to produce the energy used in fabricating the components, the amount of energy used to extract the raw fuel used to generate the electricity used in fabricating the components, etc. Other factors may include, for instance, the power delivery process, the recycling/disposal costs of the components, transportation costs, etc.

At step 406, the processes having the substantially lowest exergy destruction values are identified. According to an example, the exergy destruction values resulting from processes associated with an entire life cycles of the components may be compared with each other. In this example, the exergy destruction values for the processes may be summed for each of the components. According to another example, the exergy destruction values resulting from processes associated with one or more stages in the lives of the components may be compared with each other to identify the processes having the substantially lowest exergy destruction values.

In any regard, the identifying module 112 may select the components that have undergone the process(es) having the lowest exergy destruction values during at least one of the life stages identified at step 406 for use in the design of the apparatus, as indicated at step 408. In addition, the components selected at step 408 may be outputted as discussed above with respect to step 210 in FIG. 2.

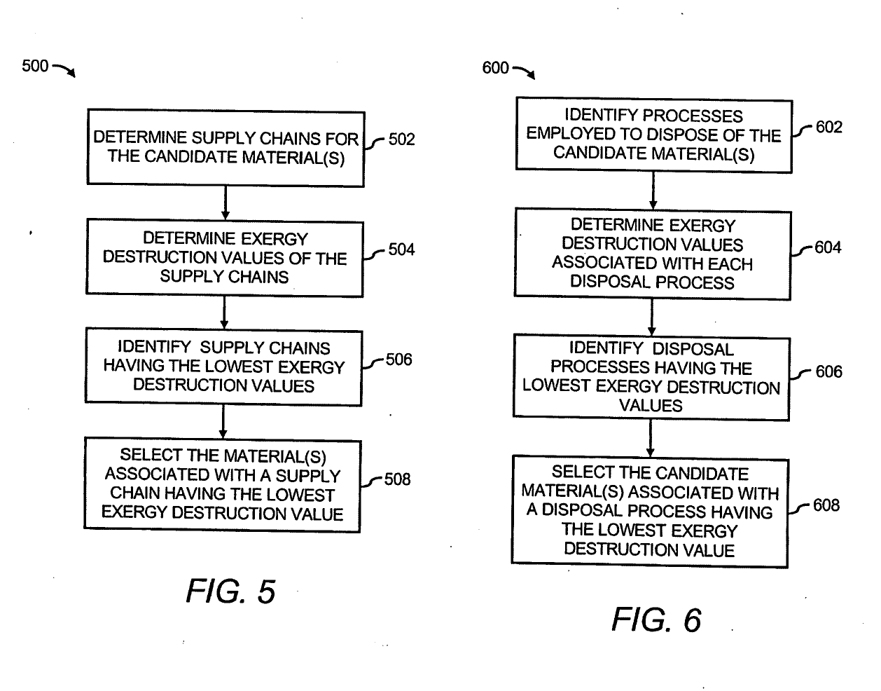

Turning now to FIG. 5, there is shown a flow diagram of a method 500 of determining the exergy destruction values of one or more candidate materials and/or one or more candidate processes used in designing the apparatus of FIG. 2, according to another example. Thus, for instance, the steps 504-508 in the method 500 comprise more detailed descriptions of an example of steps 204-208, respectively, in FIG. 2. In addition, or alternatively, the steps 502-508 contained in the method 500 may be performed in place of steps 204-208 in the method 200. Furthermore, the method 500 may be performed in place of or in conjunction with either or both of the methods 300 and 400 in FIGS. 3 and 4.

At step 502, supply chains for the one or more candidate materials are identified. The supply chains may include, for instance, various manners in which the one or more materials are transported or otherwise supplied. By way of example, the supply chains may include different forms of transportation, such as, railway, trucks, ships, etc., where each of the different forms of transportation are associated with different exergy destruction values. In addition, some or all of the one or more materials may be supplied through different candidate supply chains. The supply chains may thus be considered as candidate processes for supplying the candidate materials.

At step 504, the exergy destruction values associated with each of the candidate supply chains are determined. More particularly, for instance, the exergy destruction determining module 108 may determine the exergy destruction values of a first supply chain through which a first material is supplied and a second supply chain through which a second material is supplied, where the first material and the second material comprise compatible replacement materials for each other. By way of example, the exergy destruction determining module 108 may determine the exergy destruction values of multiple candidate processes through which the material may be supplied. As another example, the exergy destruction determining module 108 may determine the exergy destruction values of multiple candidate processes of the supply chain itself.

In determining the exergy destruction values, various other factors may be considered with regard to the energy or materials used during the process of supplying the materials. These other factors may include, for instance, the amount of raw fuel utilized to produce the energy used in supplying the materials, the amount of energy used to extract the raw fuel used to generate the electricity used in supplying the materials, etc. Additional factors may include, for instance, secondary or tertiary considerations, such as, the exergy destruction levels of the energy used and material consumed in generating the raw fuel utilized in the supply chains.

At step 506, the supply chains having the substantially lowest exergy destruction values are identified. According to an example, the exergy destruction values resulting from processes associated with entire supply chains may be compared with each other. In this example, the exergy destruction values for the supply chains may be summed for each of the supply chains. According to another example, the exergy destruction values resulting from processes associated with one or more stages in the supply of the one or more materials may be compared with each other to identify the supply chains having the substantially lowest exergy destruction values.

In any regard, the identifying module 112 may select the one or more materials that are supplied through the identified supply chains for use in the design of the apparatus, as indicated at step 508. In addition, the one or more candidate materials selected at step 508 may be outputted as discussed above with respect to step 210 in FIG. 2.

With reference now to FIG. 6, there is shown a flow diagram of a method 600 of determining the exergy destruction values of the one or more candidate materials, according to a further example. Thus, for instance, the steps 604-608 in the method 600 comprise more detailed descriptions of an example of steps 204-208, respectively, in FIG. 2. In addition, or alternatively, the steps contained 602-408 in the method 600 may be performed in place of steps 204-208 in the method 200. Furthermore, the method 600 may be performed in place of or in conjunction with one or more of the methods 300, 400, and 500 in FIGS. 3-5, respectively.

At step 602, processes employed to dispose of the one or more candidate materials are identified. The disposal processes may include, for instance, various processes in which the one or more candidate materials are either discarded or recycled, where each of the different disposal processes are associated with different exergy destruction values. In addition, some or all of the one or more candidate materials may be disposed of through different disposal processes.

At step 604, the exergy destruction values associated with each of the disposal processes are determined. More particularly, for instance, the exergy destruction determining module 108 may determine the exergy destruction values of a first disposal process through which a first material is disposed and a second disposal processes through which a second material is disposed, where the first material and the second material comprise compatible replacement materials for each other. By way of example, the first material may comprise a plastic and the second material may comprise a metal. In this example, both the plastic and the metal may be recycled, however, recycling of the metal may require greater amounts of energy and may thus be associated with a higher exergy destruction value.

In determining the exergy destruction values of the disposal processes, various other factors may be considered with regard to the materials or energy used during the disposal of the candidate materials. These other factors may include, for instance, the amount of raw fuel utilized to produce the energy used in disposing of the materials, the amount of energy used to extract the raw fuel used to generate the electricity used in disposing of the materials, etc.

At step 606, the disposal processes having the substantially lowest exergy destruction values are identified. In addition, the identifying module 112 selects the one or more candidate materials that are disposed of through the identified disposal processes for use in the design of the apparatus, as indicated at step 608.

In addition, the one or more candidate materials selected at step 608 may be outputted as discussed above with respect to step 210 in FIG. 2.

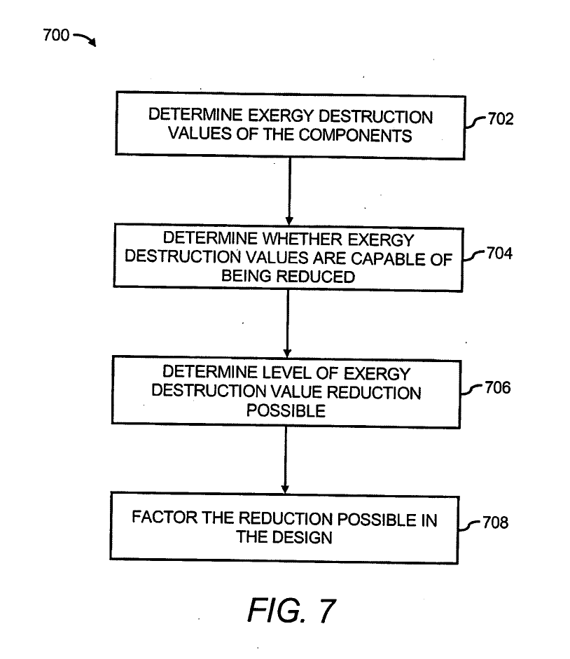

Turning now to FIG. 7, there is shown a flow diagram of a method 700 of reducing the exergy destruction values of one or more components, according to an example. The method 700 may be performed in conjunction with one or more of the methods 200-600 in FIGS. 2-6, respectively, to substantially reduce the exergy destruction values of the components, if possible. The method 700 may further be implemented or executed to substantially reduce the exergy destruction values of components that have been selected for inclusion in the design of the apparatus. In addition, or alternatively, the method 700 may be implemented or executed to determine the levels to which the exergy values of components are capable of being reduced, which may be used in selecting the one or more materials and/or the components for use in the apparatus.

At step. 702, the exergy destruction values of the components are determined in any of the manners discussed herein above. For instance, the exergy destruction values may include the exergy destroyed during fabrication of the materials used to create the components, the exergy destroyed during fabrication of the components, the exergy destroyed in supplying the materials for the components, the exergy destroyed in disposing of the components, the exergy destroyed during use of the components, etc.

At step 704, the exergy destruction determining module 108 is further configured to determine whether the exergy destruction values of the components are capable of being reduced. The potential reduction in exergy destruction may be determined for one or more stages in the life cycles of the components. By way of example, during a fabrication stage of a casing for the apparatus, the exergy destruction determining module 108 may determine whether the amount of material used for the casing may be reduced and whether the reduction would lead to a reduction in exergy destruction. As another example, the exergy destruction determining module 108 may determine the exergy destruction values associated with disposing and recycling of the casing and may select the material associated with the lowest exergy destruction disposal method.

At step 706, in response to a determination that the exergy destruction values of the components are capable of being reduced, the level of exergy destruction value reduction possible is determined. In addition, at step 708, the exergy destruction value reduction possible is factored in the apparatus design. More particularly, for instance, the exergy destruction value reduction possible for a particular component design is compared with the exergy destruction value reduction possible for a different component design. The component design having the lower exergy destruction value from the possible reductions is identified as the component to be used in the design of the apparatus.

The design of the apparatus with the reduction in exergy destruction value applied may also be outputted as discussed above with respect to step 210 in FIG. 2.

Some or all of the operations set forth in the methods 200-700 may be contained as utilities, programs, or subprograms, in any desired computer accessible medium. In addition, the methods 200-700 may be embodied by computer programs, which can exist in a variety of forms both active and inactive. For example, they may exist as software program(s) comprised of program instructions in source code, object code, executable code or other formats. Any of the above may be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

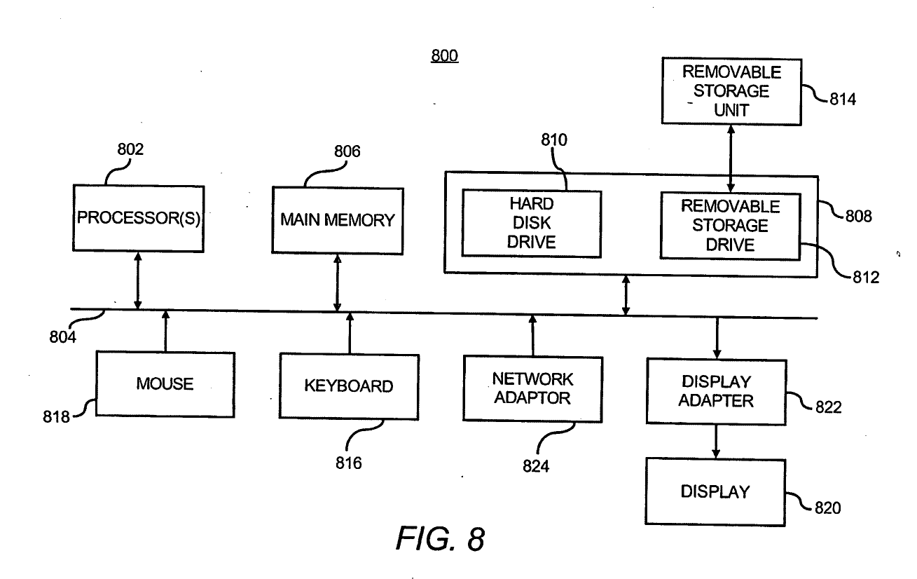

FIG. 8 illustrates a block diagram of a computing apparatus 800 configured to implement or execute the design tool 102 depicted in FIG. 1, according to an example. In this respect, the computing apparatus 800 may be used as a platform for executing one or more of the functions described hereinabove with respect to the design tool 102.

The computing apparatus 800 includes a processor 802 that may implement or execute some or all of the steps described in the methods 200-700. Commands and data from the processor 802 are communicated over a communication bus 804. The computing apparatus 800 also includes a main memory 806, such as a random access memory (RAM), where the program code for the processor 802, may be executed during runtime, and a secondary memory 808. The secondary memory 808 includes, for example, one or more hard disk drives 810 and/or a removable storage drive 812, representing a floppy diskette drive, a magnetic tape drive, a compact disk drive, etc., where a copy of the program code for the methods 200-700 may be stored.

The removable storage drive 810 reads from and/or writes to a removable storage unit 814 in a well-known manner. User input and output devices may include a keyboard 816, a mouse 818, and a display 820. A display adaptor 822 may interface with the communication bus 804 and the display 820 and may receive display data from the processor 802 and convert the display data into display commands for the display 820. In addition, the processor(s) 802 may communicate over a network, for instance, the Internet, LAN, etc., through a network adaptor 824.

It will be apparent to one of ordinary skill in the art that other known electronic components may be added or substituted in the computing apparatus 800. It should also be apparent that one or more of the components depicted in FIG. 8 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the scope of the invention, which is intended to be defined by the following claims—and their equivalents—in which all terms are meant in their broadest reasonable sense unless otherwise indicated.

What is claimed is:

1. A method of designing an apparatus formed of at least one component to substantially minimize exergy destruction, said method comprising:
identifying at least one of one or more candidate materials and one or more candidate processes, wherein the one or more candidate materials are capable of being used in forming the at least one component and wherein the one or more candidate processes are associated with either or both of the one or more candidate materials and the at least one component;
determining exergy destruction values of at least one of the one or more candidate materials and the one or more candidate processes; and
selecting at least one of the one or more candidate materials and the one or more candidate processes having the substantially lowest exergy destruction values for the apparatus design.

2. The method according to claim 1, further comprising:
at least one of receiving and determining exergy destruction values of the identified at least one of the one or more candidate materials and the one or more candidate processes.

3. The method according to claim 1, wherein identifying the one or more candidate materials further comprises selecting the one or more candidate materials from a pool of candidate materials capable of being used to form the at least one component, and wherein selecting the one or more candidate materials further comprises selecting the one or more candidate materials having the substantially lowest exergy destruction values in the pool of candidate materials.

4. The method according to claim 1, wherein identifying the one or more candidate processes further comprises identifying one or more candidate processes employed to at least one of extract, fabricate, dispose of, and re-use the one or more candidate materials, wherein determining exergy destruction values further comprises determining the exergy destruction values associated with each of the identified one or more candidate processes, and wherein selecting the one or more candidate processes further comprises selecting the one or more candidate processes having the substantially lowest exergy destruction values.

5. The method according to claim 4, further comprising:
selecting one or more candidate materials that are at least one of extracted, fabricated, disposed of, and re-used through the selected one or more candidate processes having the substantially lowest exergy destruction values.

6. The method according to claim 1, wherein identifying the one or more candidate processes further comprises identifying one or more candidate processes employed to at least one of fabricate, use, dispose of, and re-use the at least one component, wherein determining the exergy destruction values further comprises determining the exergy destruction values associated with each of the identified one or more candidate processes, and wherein selecting the one or more candidate processes further comprises selecting the one or more candidate processes having the substantially lowest exergy destruction values.

7. The method according to claim 6, further comprising:
selecting the at least one component that is at least one of fabricated, used, disposed of, and re-used through the selected one or more candidate processes having the substantially lowest exergy destruction values.

8. The method according to claim 1, further comprising:
determining supply chains for at least one of the one or more candidate materials and the one or more candidate processes;
determining exergy destruction values of the supply chains; and
wherein selecting the at least one of the one or more candidate materials and the one or more candidate processes further comprises selecting at least one of the one or more candidate materials and the one or more candidate processes associated with the supply chain having the substantially lowest exergy destruction value.

9. The method according to claim 1, wherein determining exergy destruction values of the one or more candidate materials further comprises determining the exergy destruction values of the one or more candidate materials during one or more life cycle stages of the one or more candidate materials.

10. The method according to claim 1, further comprising:
determining exergy destruction value of the at least one component;
determining whether the exergy destruction value of the at least one component is capable of being reduced;
in response to a determination that the exergy destruction value is capable of being reduced, determining a level to which the exergy destruction value is capable of being reduced; and
factoring the level to which the exergy destruction value is capable of being reduced in the design of the apparatus.

11. The method according to claim 10, wherein determining whether the exergy destruction value of the at least one component is capable of being reduced further comprises determining whether at least one of the amount of material used to fabricate the at least one component and the amount of energy used to at least one of fabricate and use the at least one component is capable of being reduced.

12. A computer-implemented design tool for designing an apparatus formed of at least one component to substantially minimize exergy destruction, said computer-implemented design tool comprising:
an input module configured to receive data regarding at least one of one or more material and one or more process options;
a material/process identifying module configured to identify at least one of one or more candidate materials and one or more candidate processes from the inputted data, wherein the one or more candidate materials are capable of being used in forming the at least one component, and wherein the one or more candidate processes are associated with either or both of the one or more candidate materials and the at least one component;
an exergy destruction determining module configured to determine exergy destruction values of the at least one of the one or more candidate materials and the one or more candidate processes;
a comparing module configured to compare the exergy destruction values of the at least one of the one or more candidate materials and the one or more candidate processes; and
an identifying module configured to select at least one of the one or more candidate materials and the one or more candidate processes that have the substantially lowest exergy destruction values for use in the apparatus design.

13. The computer-implemented design tool according to claim 12, further comprising:
an output module configured to output a design of the apparatus containing the selected at least one of the one or more candidate materials and the one or more processes having the substantially lowest exergy destruction values.

14. The computer-implemented design tool according to claim 12, wherein the input module is further configured to at least one of receive and calculate the exergy destruction values of the one or more candidate materials and the one or more candidate processes.

15. The computer-implemented design tool according to claim 12, wherein the exergy destruction determining module is further configured to determine exergy destruction values associated with one or more candidate processes employed to at least one of extract, fabricate, dispose of, and re-use the one or more candidate materials, wherein the comparing module is further configured to compare the exergy destruction values of the one or more candidate processes, and wherein the identifying module is further configured to select the one or more candidate materials associated with the one or more candidate processes having the substantially lowest exergy destruction values.

16. The computer-implemented design tool according to claim 12, wherein the exergy destruction determining module is further configured to determine exergy destruction values associated with one or more candidate processes employed to at least one of fabricate, use, dispose of, and re-use the at least one component, wherein the comparing module is further configured to compare the exergy destruction values of the one or more candidate processes, and wherein the identifying module is further configured to select the at least one component that is at least one of fabricated, used, disposed of, and re-used through the selected one or more candidate processes having the substantially lowest exergy destruction values.

17. The computer-implemented design tool according to claim 12, wherein the material/process identifying module is further configured to determine supply chains for at least one of the one or more candidate materials and the one or more candidate processes, wherein the exergy destruction determining module is is further configured to determine exergy destruction values of the supply chains, and wherein the identifying module is further configured to select the at least one of the one or more candidate materials and the one or more candidate processes associated with the supply chain having the substantially lowest exergy destruction value.

18. The computer-implemented design tool according to claim 12, wherein the exergy destruction determining module is further configured to determine exergy destruction values of the one or more candidate materials during one or more life cycle stages of the one or more candidate materials.

19. A computer readable storage medium on which is embedded one or more computer programs, said one or more computer programs implementing a method of designing an apparatus formed of at least one component to substantially minimize exergy destruction, said one or more computer programs comprising a set of instructions for:
identifying at least one of one or more candidate materials and one or more candidate processes, wherein the one or more candidate materials are capable of being used in forming the at least one component and wherein the one or more candidate processes are associated with either or both of the one or more candidate materials and the at least one component;
determining exergy destruction values of at least one of the one or more candidate materials and the one or more candidate processes; and
selecting at least one of the one or more candidate materials and the one or more candidate processes having the substantially lowest exergy destruction values for the apparatus design.

20. The computer readable storage medium according to claim 19, said one or more computer programs further comprising a set of instructions for:
identifying the one or more candidate processes employed to at least one of extract, fabricate, dispose of, and re-use the one or more candidate materials;
determining exergy destruction values associated with each of the identified one or more candidate processes;
selecting the one or more candidate processes having the substantially lowest exergy destruction values; and
selecting one or more candidate materials that are at least one of extracted, fabricated, disposed of, and re-used through the selected one or more candidate processes having the substantially lowest exergy destruction values.
